(19) United States
(12) Patent Application Publication
(10) Pub. No.: US 2008/0097846 A1
(43) Pub. Date: Apr. 24, 2008

(54) Information Management System, Information Management Server, Portable Terminal, and Portable Terminal Control Program

(75) Inventors: Ayumu Oikawa, Tokyo (JP); Hiroshi Watanabe, Tokyo (JP)

Correspondence Address: BIRCH STEWART KOLASCH & BIRCH, PO BOX 747, FALLS CHURCH, VA, 22040-0747, US

(73) Assignee: Japan Tobacco Inc., Tokyo (JP)

(21) Appl. No.: 11/792,683

(22) PCT Filed: Mar. 23, 2005
(86) PCT No.: PCT/JP05/05205

§ 371 Date: Jun. 26, 2007

(30) Foreign Application Priority Data
Dec. 28, 2004 (JP) 2004-378720

(51) Int. Cl. G06Q 99/00; H04M 11/00

(52) U.S. Cl. 705/14

(57) ABSTRACT

An information management system 200 including a portable telephone 100 having a settlement unit 107 which performs electronic settlement and an information management server 50 which gathers and manages settlement information, wherein the portable telephone 100 includes a settlement information transmission unit 117 which transmits the settlement information to the information management 50, a receiving unit 140 which receives prize data from the information management server 50, a content storage unit 130 and an incentive hold unit 135 which store therein the prize data received, and the information management server 50 includes a settlement information receiving unit 203 which receives the settlement information and stores the received settlement information in a settlement breakdown database 52 and a transmission unit 207 which transmits the prize data stored in the content storage unit 60 to the portable telephone 100 if having received the settlement information from the portable telephone 100.

### TECHNICAL FIELD

The present invention relates to an information management system, an information management server, a portable terminal, and a portable terminal control program and, more particularly to, an information management system that manages settlement information of electronic settlement by use of a portable terminal at the time of purchase of a product.

### BACKGROUND ART

Recently, a mobile device such as a portable telephone has been provided with various functions in addition to original communication functions, becoming highly-functional and diverse increasingly. One of the functions is electronic settlement by use of a mobile device. Electronic settlement by use of a mobile device has been put to practical use gradually as advancing individual authentication technologies and communication encryption technologies. An example of a settlement system by use of a conventional portable type information terminal is described in, for example, Patent Document 1.

Patent Document 1: Japanese Laid-open patent publication No. 2001-5883

### DISCLOSURE OF THE INVENTION

As a ubiquitous age is coming, it becomes an important problem for business enterprises how to gather necessary information rapidly. In a conventional information management system, for example, information of electronically settled purchase is periodically transmitted via a network to an information management company from a store affiliated with the information management company and then analyzed in the information management company, a result of which is provided to the business enterprises. Therefore, the conventional information management system finds it difficult to gather information in real time when a product is purchased. Further, information of transaction in an unaffiliated store cannot be gathered by the conventional information management system.

The present invention has been achieved in view of the above problems, and an object thereof is to provide an information management system, information management server, a portable terminal, and a portable terminal control program that can gather in real time settlement information of electronic settlement by use of a portable terminal at the time of purchase of a product.

According to the present invention, there is provided an information management system including a portable terminal having a settlement unit which performs electronic settlement and a server that gathers and manages settlement information of electronic settlement performed by the portable terminal, wherein:

the portable terminal includes:
an information transmission unit which transmits the settlement information to the server;
a data receiving unit which receives prize data from the server after transmission of the settlement information to the server; and
a prize data storage unit which stores therein the prize data received by the data receiving unit; and

the server includes:
an information receiving unit which receives the settlement information;
a settlement information database which stores therein the settlement information received;
a prize data storage unit which stores therein the prize data to be sent back to the portable terminal when the settlement information is received by the information receiving unit; and
a data transmission unit which transmits the prize data to the portable terminal when the settlement information is received from the portable terminal.

The portable terminal here refers to, for example, a portable telephone or a PDA. Further, the prize data refers to incentive data, for example, data which is received as a reward or an incentive in return for transmission of settlement information to the server and includes incentive information such as a product prize or a cash prize and a point rebate service or an application program executable in the portable terminal and contents such as audio data, image data, and animation data reproducible in the portable terminal. The animation data may be, for example, Flash (trademark) and is displayed on a screen during a transmission waiting time in return for transmission of settlement information. The application program is a Java (registered trademark) application program, for example, i-Appli of i-mode provided by NTT DoCoMo, EZ-Appli (BREW (registered trademark)) provided by au, or V-Appli provided by Vodafone (registered trademark).

The settlement unit of the portable terminal is constituted of, for example, a non-contact type IC card for electronic settlement such as Felica (trademark) or an infrared communication unit which performs communication of settlement information with a POS system or the like and an electronic settlement application program execution unit.

According to the present invention, there is provided prize data to a user in return for transmission of settlement information to the server, thereby enabling motivating the user to transmit settlement information to the server. This provides an information management system that may gather settlement information in real time. The thus gathered information may be utilized quickly and effectively, thereby improving a value of the information.

In the above-described information management system, the portable terminal may include a storage unit which stores therein contents and a program, a control unit which reproduces and executes the contents and the program respectively, and a display unit which displays a screen which is displayed when the control unit reproduces and executes the contents and the program respectively, wherein if the settlement unit in the portable terminal performs electronic settlement, the control unit may cause the display unit to display the screen so that the information transmission unit may transmit the settlement information to the server during a time when the screen is being displayed.

A screen here refers to a screen displaying, for example, an animation, a still image, or a game. By this constitution, it is possible to display the screen on the display unit of the portable terminal during transmission of settlement information to the server so that a user may enjoy even during transmission waiting time, thereby motivating the user to transmit information. With this, there is provided an information management system having an improved efficiency to gather settlement information in real time.

In the above-described information management system, the portable terminal may include an acceptance unit which accepts an instruction for transmission of the settlement information to the server. If the instruction is accepted by the acceptance unit, the control unit may cause the display unit to display the screen and the information transmission unit may transmit the settlement information to the server.

By this constitution, if a user fails in connection to the server due to a poor communication condition, the user may move to a place having a good communication condition to immediately transmit settlement information again, so that the settlement information may be gathered at the earliest time as possible after purchase of a product.

In the above-described information management system, the portable terminal may include a notification unit which transmits an information transmission notification before transmitting the settlement information to the server and a content receiving unit which receives a new content or program from the server and stores it in the storage unit, while the server may include an acceptance unit which accepts the information transmission notification, a storage unit which stores therein the new content and program, and a content transmission unit which transmits the new content or program to the portable terminal when the information transmission notification is accepted.

By this constitution, it is possible to provide the portable terminal with a new content or program in return for transmission of settlement information from the server so that the user may enjoy transmission of the settlement information to the server and be motivated to transmit the settlement information.

According to the present invention, there is provided a portable terminal including a settlement unit which performs electronic settlement, an information transmission unit which transmits settlement information of electronic settlement performed by the settlement unit to an information management server, and a data receiving unit which receives prize data from the information management server after the settlement information is transmitted to the information management server and stores the prize data in the storage unit.

The above-described portable terminal may include a storage unit which stores therein a content and a program, a control unit which reproduces and executes the content and program respectively, and a display unit which displays a screen which is displayed when the control unit reproduces and executes the content and program respectively. If the electronic settlement is performed by the settlement unit, the control unit may cause the display unit to display the screen so that the information transmission unit may transmit the settlement information to the information management server during a time when the screen is being displayed.

The above-described portable terminal may include an acceptance unit which accepts an instruction to transmit the settlement information to the information management server. If the acceptance unit accepts the instruction, the control unit may cause the display unit to display the screen and the information transmission unit may transmit the settlement information to the information management server.

The above-described portable terminal may include a sound output unit which produces a sound. In the portable terminal, the content stored in the storage unit includes audio data which may be produced by the sound output unit, so that the audio data may be output from the sound output unit simultaneously when the screen is displayed on the display unit.

By this constitution, it is possible to provide the user with an entertainment in richer expressions not only by images but also by sounds.

The above-described portable terminal may have a vibration unit which vibrates in a predetermined vibration pattern. The vibration unit may vibrate in the predetermined vibration pattern simultaneously when the screen is displayed on the display unit.

By this constitution, it is possible to provide the user with an entertainment in richer expressions not only by images and sounds but also by vibrations.

The above-described portable terminal may include a light source unit which may light up at a predetermined lighting-up/blinking interval and in a predetermined arrangement, and color pattern. The light source unit may light up at the predetermined lighting-up/blinking interval and in the arrangement and color pattern simultaneously when the screen is displayed on the display unit.

By this constitution, it is possible to provide the user with an entertainment in richer expressions not only by images, sounds, and vibrations but also by light.

According to the present invention, there is provided an information management server that includes an information receiving unit which receives settlement information from a portable terminal which performs electronic settlement, a settlement information database which stores the settlement information received, a prize data storage unit which stores therein the prize data to be sent back to the portable terminal if the settlement information is received by the information receiving unit, and a data transmission unit which transmits the prizes data to the portable terminal if the settlement information is received from the portable terminal.

According to the present invention, there is provided a program causing a portable terminal that includes a settlement unit which performs electronic settlement, a prize data storage unit which stores therein prize data to be transmitted from an information management server, a content storage unit which stores therein a content and a program, and a display unit, to function as:

an execution means which reproduces and execute the content and the program respectively if the electronic settlement is performed by the settlement unit;

a display control means which displays on a screen of the display unit the content and the program if the content and the program are reproduced and executed respectively by the execution means;

an information transmission means which transmits settlement information of electronic settlement performed by the settlement unit to the information management server during the screen is being displayed; and

a data receiving means which receives the prize data from the information management server after the settlement information is transmitted to the information management server and stores the prize data in the prize data storage unit.

In the above-described program, the portable terminal may be caused to function as an acceptance means which accepts an instruction to transmit the settlement information to the information management server. If the instruction is accepted by the acceptance means, the execution means may reproduce and execute the content and the program respectively, and the information transmission means may transmit the settlement information to the information management server simultaneously when the screen is displayed on the display unit by the display control means.

In the above-described information management system, the prize data may include first prize data to be transmitted to the portable terminal by the data transmission unit of the server immediately after the settlement information is received by the server from the portable terminal, and second prize data to be donated posteriori for each user account of the portable terminal after the settlement information is received by the server from the portable terminal.

The first prize data here may include, for example, information of a money amount or a point of a product prize or a cash prize to be donated through a premium lottery carried out in real time when data is transmitted upon purchase of a product. Further, the second prize data may refer to, for example, an incentive to be donated afterwards which may be compensation for an expense on a user for transmission of the settlement information and may include incentive information of a product prize or a cash prize and a point to be donated. It is to be noted that the first prize data is to be transmitted “immediately” with respect to the second prize data to be donated afterwards, so that simultaneity is not necessarily qualified.

By this constitution, the first prize data which is transmitted immediately after the settlement information is received from the portable terminal and the second prize data which is donated afterwards may be separated from each other, to perform only processing by use of the first prize data previously, thereby performing processing when the settlement information is transmitted from the portable terminal more quickly.

In the above-described information management system, the server may include a first allotment table which registers a product to which the first prize data is to be transmitted, a second allotment table which registers a product to which the second prize data is to be donated, a first decision unit which decides whether the product registered in the first allotment table is included or not immediately after the settlement information is received by the information receiving unit, a second decision unit which decides whether the product registered in the second allotment table is included or not posteriori after the settlement information is received by the information receiving unit, a first determination unit which determines the prize data to be transmitted to the portable terminal to which the settlement information is transmitted if the first decision unit decides that the product is included, and a second determination unit which determines the prize data to be donated to a user account of the portable terminal to which the settlement information is transmitted if the second decision unit decides that the product is included.

By this constitution, it is possible to quickly perform transmission of the first prize data, which needs to be processed in real time when the settlement information is received from the portable terminal. Further, it is possible to donate an incentive posteriori as compensation for a transmission expense to be born by the user, thereby motivating the user to transmit information. It is thus possible to realize well fitted trigger-based marketing capable of gathering information based on such a trigger that the user at the time of purchase of a product may be a source.

In the above-described information management system, the server may include an allotment history storage unit which stores therein allotment history information of the prize data transmitted by the data transmission unit for each account of a user of the portable terminal. When the settlement information is received by the information receiving unit, the first determination unit and the second determination unit may refer to the allotment history storage unit to thereby determine the prize data to be transmitted by the data transmission unit and store the allotment history information in the allotment history storage unit.

It is to be noted that the allotment history information may include an allotment amount of the prize data, the number of times of allotment and the like, thus enabling upgrading a level of the prize data to be transmitted and changing a type of the prize data depending on the number of times of allotment and the like.

In the above-described information management system, the portable terminal may include a procedure table which stores therein a chained order of a plurality of contents or programs stored in the prize data storage unit, so that, in the portable terminal, the control unit may sequentially reproduce or execute the plurality of contents or programs respectively in the chained order described in the procedure table each time the settlement information is transmitted to the server.

By this constitution, chained continuity may be given to contents or programs presented to the user when the settlement information is transmitted, so that the user may have a wish to see a sequel, thereby causing opportunity, that is, a trigger to be triggered to have an intention to transmit information to continue for a long period.

As described later, according to the present invention, dynamic e-commerce may be realized by which profits circle virtuously.

An arbitrary combination of the above components and representation of the present invention replaced among a method, an apparatus, an information management system, a record medium, or a computer program are also effective as a valid aspect of the present invention.

According to the present invention, there is provided an information management system that can gather in real time the settlement information of electrical settlement performed by a portable terminal when a product is purchased.

### BRIEF DESCRIPTION OF THE DRAWINGS

The above-described objects and other objects, features, and advantages may be further apparent by description of the following preferred embodiments and accompanying drawings.

FIG. 1 is an explanatory constitutional system diagram of an information management system according to an embodiment of the present invention;

FIG. 2 is a functional block diagram of a constitution of the information management system of FIG. 1;

FIG. 3 is an external view of a portable telephone of FIG. 2;

FIG. 4 is an outlined block diagram of a constitution of the portable telephone of FIG. 2;

FIG. 5 is a flowchart of one example of electronic settlement processing by the portable telephone;

FIG. 6 is an illustration of one example of each of a content display screen and an incentive display screen on a liquid crystal display unit of the portable telephone of FIG. 2;

FIG. 7 is a flowchart of one example of settlement information gathering and analysis processing by the information management server of FIG. 2;

FIG. 8 is a chart of one example of operations of the information management system of FIG. 1;

FIG. 9 is a functional block diagram of a constitution of an information management system according to an embodiment of the present invention;

FIG. 10 is a flowchart of one example of electronic settlement processing by the portable telephone of FIG. 9;

FIG. 11 is a flowchart of one example of electronic settlement/gathering processing by information management server of FIG. 9;

FIG. 12 is an illustration of an untransmitted information screen in an information management system of an embodiment of the present invention;

FIG. 13 is an explanatory illustration of a dynamic business model according to the present invention;

FIG. 14 is a diagram of one example of a structure of a settlement breakdown database of FIG. 1;

FIG. 15 is a diagram of one example of a structure of an allotment management database of FIG. 1;

FIG. 16 is a diagram of one example of a structure of a product management database of FIG. 1;

FIG. 17 is a diagram of one example of a structure of a credit settlement database of FIG. 1;

FIG. 18 is a functional block diagram of details of an incentive donation unit and an allotment management database of an information management system according to an embodiment of the present invention; and

FIG. 19 is a diagram of one example of a structure of each of a premium allotment table and an incentive allotment table of FIG. 18.

### BEST MODE FOR CARRYING OUT THE INVENTION

An embodiment of the present invention will be described below with reference to drawings. Identical reference numerals are given to identical components in all drawings, and description will not be repeated.

### First Embodiment

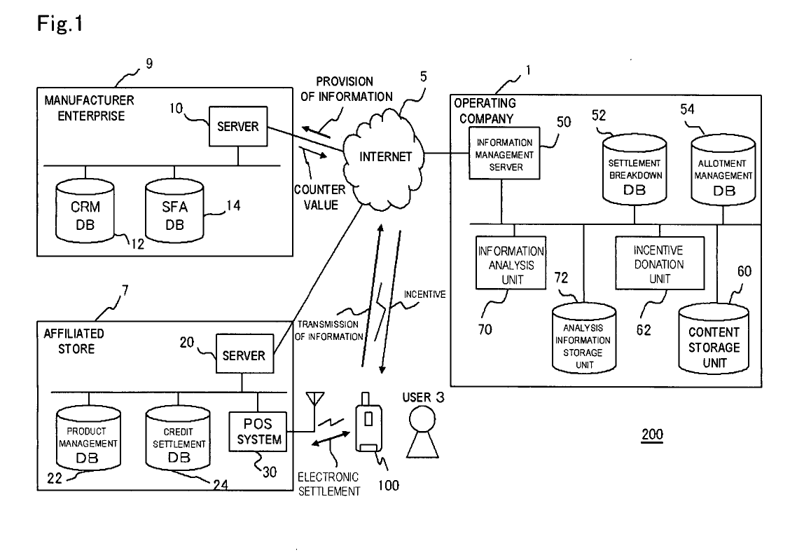

FIG. 1 is an explanatory constitutional system diagram of an information management system according to an embodiment of the present invention. The present embodiment of the information management system 200 enables an information management server 50 to gather in real time settlement information of electronic settlement by use of portable telephone 100 with a POS system 30 as triggered by the electronic settlement when a user 3 purchases a product.

To be “in real time” here refers to doing something mostly simultaneously with electronic settlement when a user 3 purchases a product. Alternatively, it means doing so immediately after the user moves to another place with a good communication condition if the user fails in connection to the server because the user is in a place with a poor communication condition. That is, product sales information can be gathered at the earliest time as possible after purchase of a product, thereby improving a contact with a customer in a consumption chain.

Settlement information here refers to for example, customer information including a sex and an age group, purchase information including a purchase day/time, a purchase store, a product and a purchase money amount. It is to be noted that although a case where the portable telephone 100 is used as a portable terminal that performs electronic settlement will be described in this embodiment, the present invention is not limited thereto. Any other terminals than the portable telephone 100, for example, PDA may be used.

Further, an operating company 1 refers to a company that administers the present information management system 200 and includes the information management server 50, a settlement breakdown database (which is indicated as “settlement breakdown DB” in the drawings) 52, an allotment management database (which is indicated as “allotment management DB” in the drawings) 54, a content storage unit 60, an incentive donation unit 62, an information analysis unit 70, and an analysis information storage unit 72.

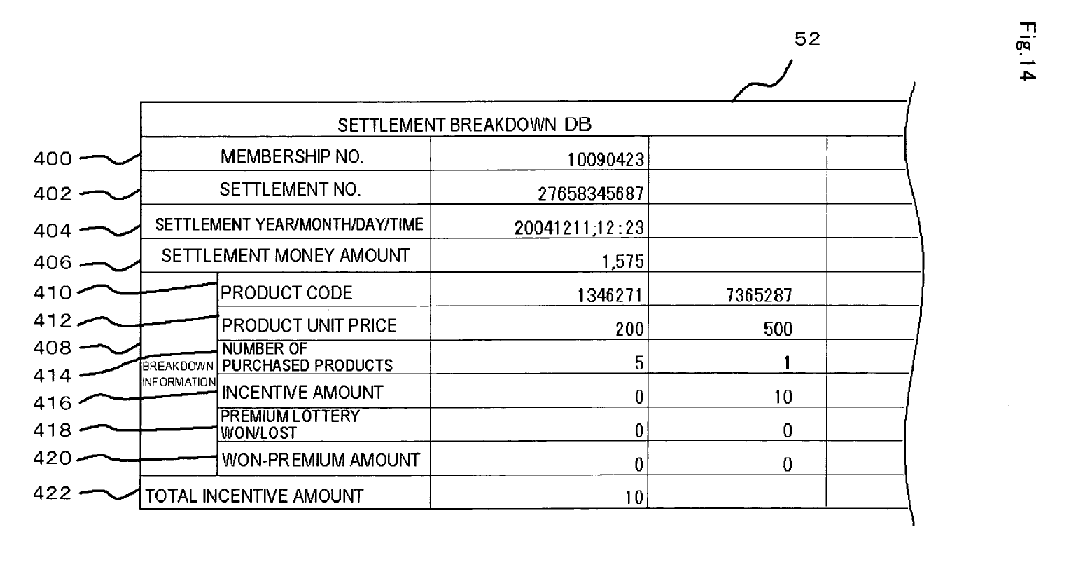

The information management server 50 gathers settlement information in real time from the portable telephone 100 and stores the settlement information in the settlement breakdown database 52. This settlement breakdown database 52 may have such a structure as shown in FIG. 14, for example. The settlement breakdown database 52 may manage information about a breakdown of purchase of a product in each operation of settlement by a registered member in the operating company 1. It is to be noted that the registered member refers to a member who is registered through prior permission of using information about purchase of a product for a purpose of business.

For example, the settlement breakdown database 52 may include a registered member's membership number 400, a settlement number 402 serving as an individual number of each settlement utilized in purchase of a product by each member, a settlement year/month/day/time 404, and a settlement money amount 406. The settlement breakdown database 52 may further include a product code 410 of each product purchased, a product unit price 412, a number of purchased products 414, an incentive amount 416 indicating a money amount serving as an incentive in a case where a purchased product corresponds to an incentive, a premium lottery WON/LOST 418 indicating whether to perform a drawing for a product prize or a cash prize at the time of data transmission, and a won-premium amount 420 indicating a money amount or a point amount of a winner of the lottery, and a total incentive amount 422 indicating a total incentive amount paid in each settlement transaction which are included in breakdown information 408 of a product purchased in each settlement transaction.

The membership number 400 is separately registered in a member information table, not shown, together with member information. Further, the product code 410 is also registered separately in a product information table, not shown, together with the product information such as the product unit price 412.

The incentive donation unit 62 donates and transmits prize data to the portable telephone 100 in return for transmission of the settlement information. The prize data here refers to incentive data, for example, data to be donated to the portable telephone 100 as a reward or an incentive in return for transmission of settlement information to the information management server 50, which includes a product prize or a cash prize, incentive information such as a point rebate service, or an application program or a content such as audio data, image data, animation data executable or reproducible in the portable telephone 100 respectively. For example, the incentive donation unit 62 accesses the allotment management database 54 to transmit, to the portable telephone 100, the incentive information showing an incentive calculated on the basis of an allotment rate predetermined with a manufacturer enterprise 9.

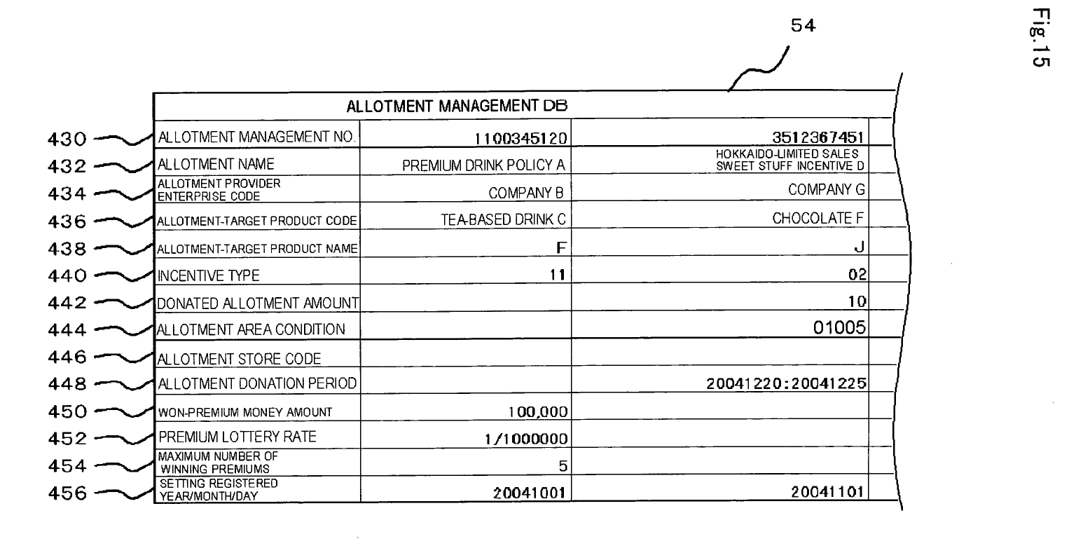

It is to be noted that the allotment management database 54 may have such a structure as shown in FIG. 15, for example. The allotment management database 54 is used by the operating company 1 to manage information about an incentive and an allotment rate and an allotment money amount of a premium lottery provided by each manufacturer enterprise 9. For example, the allotment management database 54 may include an allotment management number 430 automatically assigned as a management number of the present database, an allotment name 432, an allotment provider enterprise code 434, an allotment-target product code 436, an allotment-target product name 438, an incentive type 440 indicating a classification of an incentive donated posteriori or a premium lottery performed in real time upon data transmission at the time of purchase of a product, a donated allotment money amount 442, an allotment area condition 444, an allotment store code 446, an allotment donation period 448, a won-premium money amount 450, a premium lottery rate 452, a maximum number of winning premiums 454, a setting registered year/month/day 456.

The incentive type 440 may be donated, for example, only to limited areas or supply-chain stores and may be of a code system by which they may be classified roughly. For example, such setting may be possible that “01” indicates an incentive over a country, “02” indicates an area-limited incentive, “03” indicates a supply-chain store-limited incentive, “04” indicates a store-limited incentive, and “11” indicates a premium lottery. A code of the incentive type 440 is registered beforehand in a table, not shown.

If “02” and “03” are specified in the incentive type 440, the allotment area condition 444 and the allotment store code 446 are indispensable respectively. For example, as the allotment area condition 444, “01005” corresponds to area of Hokkaido Sapporo, “05112” corresponds to area of Minato-ku, Tokyo, “09121” corresponds area of Sannomiya, Kobe-city, Hyogo-pref. and the like, which are registered beforehand in a table, not shown. Further, as the allotment store code 446, for example, “01000” corresponds to an entire L chain, “01145” corresponds to an L-chain NishiSinbashi-store, “05234” corresponds to an S-chain Ohsu-store, and the like, which are registered beforehand in a table, not shown.

The content storage unit 60 stores beforehand contents to be transmitted by the incentive donation unit 62 to the portable telephone 100. The contents may be, for example, a movie format file such as Flash (trademark), which is displayed on the screen of the portable telephone 100 during a transmission waiting time in return for transmission of settlement information. The movie file format is not limited in particular as far as it is capable of operating in the portable telephone 100. For example, they may include an amc (AU Mobile Phone Movie File) file, a 3gp (3rd Generation Partnership Project) file, a 3g2 file, an mp4 (MPEG-4 Movie) file, a noa (Noah Archive) file, an asf (Windows Media Video) file, a Nancy (trademark), file, a Quick Time (trademark) format file and the like. An application program refers to a Java (registered trademark) application program programs, for example, i-Appli of i-mode provided by NTT DoCoMo, EZ-Appli (BREW (registered trademark) provided by au, or V-Appli provided by Vodafone (registered trademark), including a game or standby screen, for example.

The information analysis unit 70 sums up purchase information pieces and analyzes them based on settlement information stored in the settlement breakdown database 52 and stores an analysis result in the analysis information storage unit 72. For example, the information analysis unit 70 sums up information pieces for each sales store area, sex, age group, and period and analyzes a sales situation of a product. A result of an analysis by the information analysis unit 70 is transmitted from the information management server 50 via the internet 5 to a server 10 in the manufacturer enterprise 9.

By the information analysis unit 70, for example, it is possible to analyze information from viewpoints of product-specific branding strategy assistance, retention of existing good customer, new customer acquisition, new customer recommendation, cross-selling, and upselling based on purchase information about a specific product by a specific customer. Further, by adding a purchase time point or an area analysis, it is possible to conduct an analysis of the information which directly relates to effective business operation assistance or supply management, for example, a consumption chain analysis, effect analysis corresponding to a royal customer, an analysis on effects about establishment of an attached call center, or an analysis on CS improvements. Moreover, it is possible to conduct a diversified analysis such as an analysis on customer hospitality, an analysis on buyer loyalty, an analysis on relationship diversification (synergy effects), an analysis on multi-channel effects, and a cross-analysis on channel optimization.

The manufacturer enterprise 9 receives information provided by the information management server 50 in the present information management system 200 and, in return for that, sends back a counter value such as an incentive to the information management server 50. The manufacturer enterprise 9 is provided with the server 10, a CRM (Customer Relationship Management) database (which is indicated as “CRM DB” in the drawings) 12, and an SFA (Sales Force Automation) database (which is indicated as “SFA DB” in the drawings) 14. The manufacturer enterprise 9 stores information received by the server 10 into the CRM database 12 and the SFA database 14. By providing these analysis information pieces from the operating company 1 to the manufacturer enterprise 9, the manufacturer enterprise 9 may promote a strategic management policy, above all, effective CRM, SFA, and SCM (Supply Chain Management), thereby forming a product planning or a business operation planning and working out a management strategy.

An affiliated store 7 refers to, for example, a supply chain store such as a convenience store or a mass retailer outlet and periodically transmits purchase information and the like to the information management server 50 in the present information management system 200. The affiliated store 7 is provided with a server 20, a product management database (which is indicated as “product management DB” in the drawings) 22, and a credit settlement database (which is indicated as “credit settlement DB” in the drawings) 24, and a POS system 30.

The server 20 transmits settlement information pieces in a lot via the internet 5 to the information management server 50 periodically, for example, once a day. These information pieces are also stored by the information management server 50 into the settlement breakdown database 52 for use in analysis by the analysis information storage unit 72. The product management database 22 stores therein management information of products to be dealt with by the affiliated store 7.

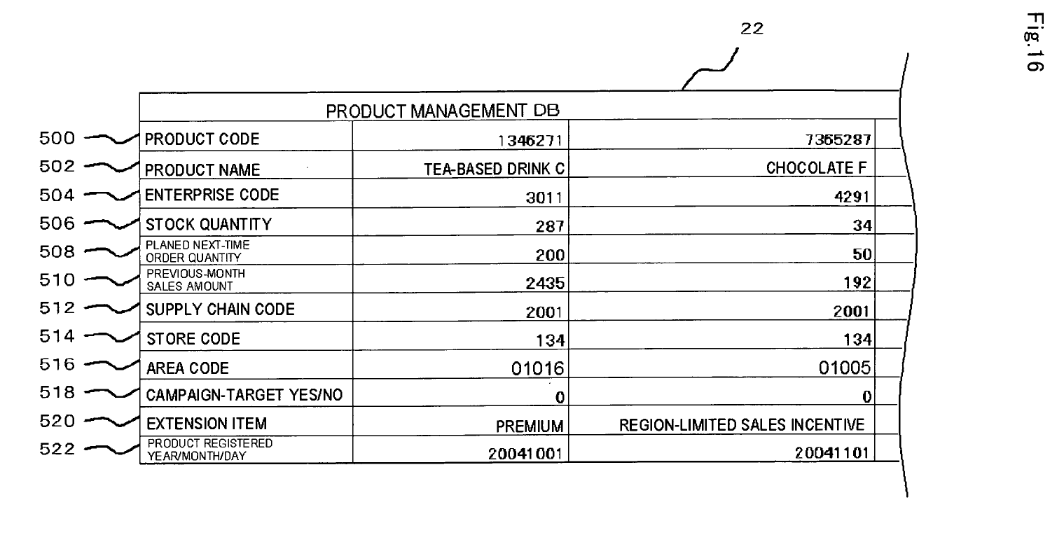

It is to be noted that the product management database 22 may have such a structure as shown in FIG. 16, for example. The product management database 22 is used by each affiliated store 7 to individually manage the products for each outlet. For example, the product management database 22 may include a product code 500, a product name 502, an enterprise code 504 of a product manufacturer, a stock quantity 506, an expected next-time order quantity 508, a previous-month sales amount 510, a supply chain code 512, a store code 514, an area code 516, campaign-target YES/NO information 518 indicating whether or not to perform a campaign in the affiliated store 7, an extension item 520 managing information of prize data including a incentive or a content provided by the operating company 1, and a product registration year/month/day/time 522. It is to be noted that these codes are supposed to be defined separately in a registration table, not shown.

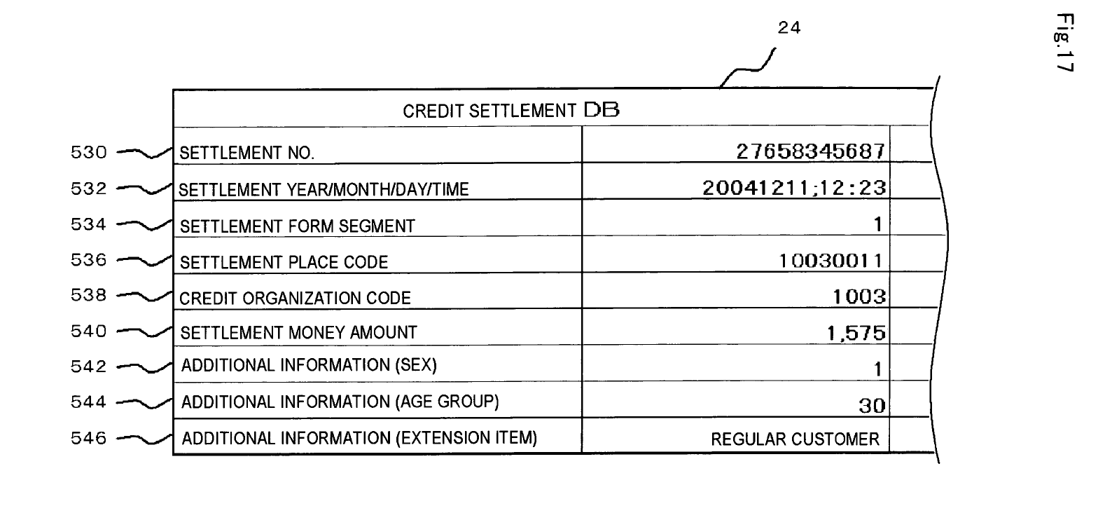

Further, the credit settlement database 24 stores therein credit information of electronic settlement performed with the portable telephone 100. The credit settlement database 24 may have such a structure as shown in FIG. 17, for example. The credit settlement database 24 manages information of credit settlement utilized by the affiliated store 7 when a customer buys a product therein. For example, the credit settlement database 24 may include a settlement number 530, a settlement year/month/day/time 532, a settlement form classification 534 indicating classification of the settlement form such as settlement using a portable telephone 100 or other forms, a settlement place code 536, a credit organization code 538 that credited settlement, a settlement money amount 540, a plurality of additional information pieces serving as items which a store clerk may enter for confirmation at, for example, a POS register in the affiliated store 7, for example, additional information (sex) 542, additional information (age group) 544, and additional information (extension item) 546. It is to be noted that these codes are supposed to be defined separately in a registration table, not shown.

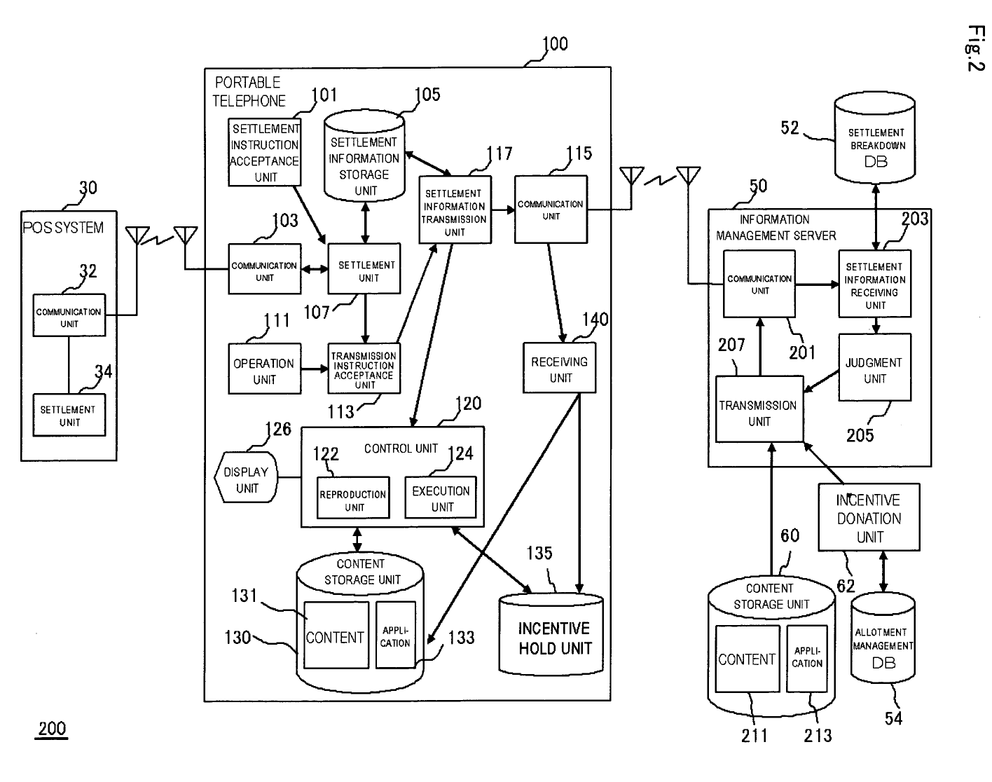

FIG. 2 is a functional block diagram of a constitution of the present embodiment of the information management system 200. In FIG. 2, a constitution of components not related to an essence of the present invention is not described and not shown.

Further, the components of the information management system may be realized by an arbitrary combination of hardware pieces and software pieces mainly such as a CPU and a memory of an arbitrary computer, a program to realize the components of the drawing loaded into the memory and a storage unit such as a hard disk on which the program is stored, and a network connecting interface. Those skilled in the art will appreciate that a method and an apparatus for realizing has various variants. Each of drawings given below shows function-specific blocks, not a hardware-specific constitution.

In the present embodiment of the information management system 200, the POS system 30 includes a communication unit 32 and a settlement unit 34. The communication unit 32 communicates with the portable telephone 100 wirelessly. The settlement unit 34 performs electronic settlement processing.

The portable telephone 100 includes a settlement instruction acceptance unit 101, a communication unit 103, a settlement information storage unit 105, a settlement unit 107, an operation unit 111, a transmission instruction acceptance unit 113, a communication unit 115, a settlement information transmission unit 117, a control unit 120, a content storage unit 130, and an incentive hold unit 135.

The settlement instruction acceptance unit 101 accepts an instruction to perform electronic settlement with the POS system 30. For example, it accepts an instruction given by the user operating the operation unit 111 to be described later or an instruction received from the POS system 30 via the communication unit 103 described later.

The communication unit 103 communicates with the POS system 30 wirelessly. For example, the communication unit 103 is an infrared communication unit (described later), a wireless communication unit (described later) of an electronic settlement non-contact type IC card, for example, Felica (trademark). If a settlement instruction is accepted by the settlement instruction acceptance unit 101, the settlement unit 107 communicates via the communication unit 103 with the POS system 103 to perform the electronic settlement processing. The settlement unit 107 is, for example, an electronic settlement application program execution unit which performs the electronic settlement processing as communicating with the POS system 30 via the communication unit 103 or an electronic settlement non-contact type IC card. The settlement information storage unit 105 stores therein settlement information of electronic settlement performed by the settlement unit 107.

The operation unit 111 is, for example, an operation button, not shown, attached to the portable telephone 100 and operated by the user 3. The transmission instruction acceptance unit 113, after settlement is performed by the settlement unit 107, accepts an instruction for the user 3 to transmit settlement information to the information management server 50.

The communication unit 115 communicates with the information management server 50 wirelessly. In this case, it connects via a wireless public circuit network to the internet 5, not shown in FIG. 2, to communicate with the information management server 50. The settlement information transmission unit 117, if an instruction to transmit settlement information is accepted by the transmission instruction acceptance unit 113, transmits the settlement information to the information management server 50 via the communication unit 115.

The control unit 120 includes a reproduction unit 122 and an execution unit 124. The reproduction unit 122 reproduces contents such as an image or a video. The reproduction unit 122 can be realized by executing a program to reproduce contents such as an image or a video in a variety of file formats. The execution unit 124 executes various application software pieces. For example, it executes application software such as a game or a standby screen. The content storage unit 130 stores therein a content 131 and application software (which is indicated as “Application” in the drawings) 133. The reproduction unit 122 and the execution unit 124 in the control unit 120 reproduce and execute the content 131 and the application software 133 stored in the content storage unit 130, respectively. The incentive hold unit 135 holds incentive information transmitted by the information management server 50.

The display unit 126 displays, for example, an image or a video if the reproduction unit 122 and the execution unit 124 in the control unit 120 reproduce and execute the content 131 and the application software 133 respectively. Besides, the display unit 126 displays various information pieces, the operation screen, and an operation or a state of the portable telephone 100 and includes, for example, a liquid crystal display. A receiving unit 140 receives incentive information or the content 131 and the application software 133 transmitted from the information management server 50 via the communication unit 115 and stores them in the content storage unit 130 or the incentive hold unit 135.

The information management server 50 includes a communication unit 201, a settlement information receiving unit 203, a judgment unit 205, and a transmission unit 207.

The communication unit 201 communicates with the portable telephone 100. In this case, it connects to the internet 5, to communicate with the portable telephone 100 via a wireless public circuit network. Communication by the communication unit 201 may be wireless or wired. The settlement information receiving unit 203 receives settlement information from the portable telephone 100 via the communication unit 201 and stores it in the settlement breakdown database 52. The judgment unit 205 decides whether reception of settlement information by the settlement information receiving unit 203 is finished or not and, if the reception is finished, notifies the transmission unit 207. In response to the notification from the judgment unit 205, the transmission unit 207 transmits via the communication unit 201 the content 211 or the application software 213 stored in the content storage unit 60.

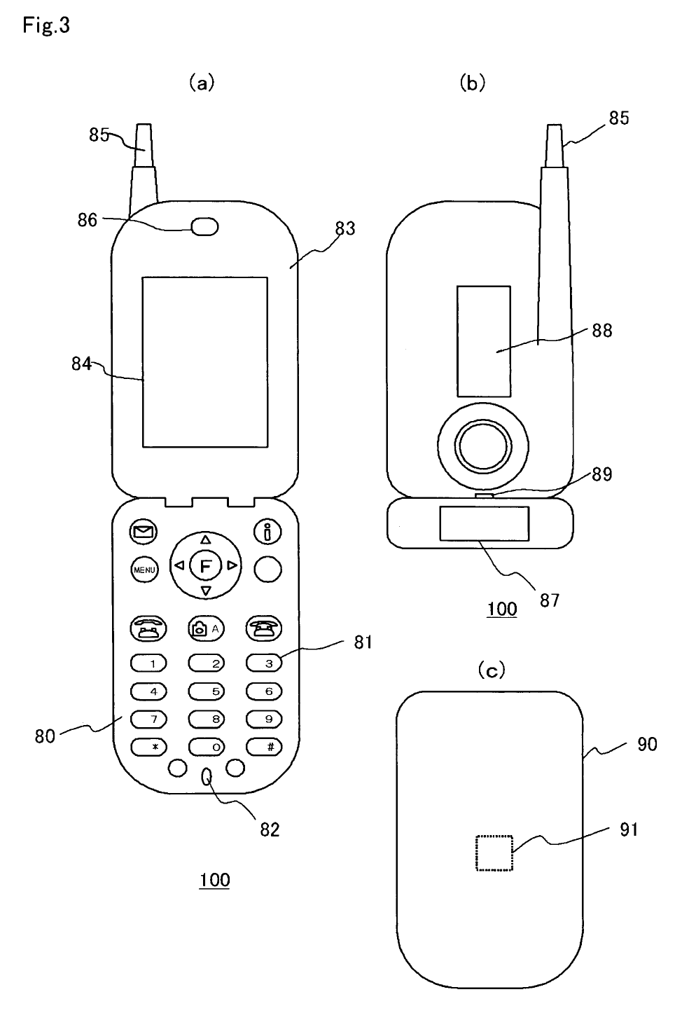

FIG. 3 is an external view of the portable telephone 100. FIG. 3(a) is a plan view of an operation surface of the two-folded type portable telephone 100 in a condition where it is opened, FIG. 3(b) is an elevation view of the portable telephone 100 in a condition where it is folded by 90 degrees, and FIG. 3(c) is a view of the reverse side of the operation surface of the portable telephone 100.

The portable telephone 100 has a body unit 80 which includes a plurality of operation buttons 81 and a microphone 82 and a cap unit 83 which includes a liquid crystal display 84 and a speaker 86. The portable telephone 100 has an infrared communication window 87. In the present embodiment, it is possible to carry out infrared communication with the POS system 30 through the infrared communication window 87.

Further, on a front side of the cap unit 83, there are provided a sub-display unit 88 constituted of a liquid crystal display and a light source unit 89 which is constituted of a plurality of LED indicators and emits a plurality of colors. Moreover, a body chassis 90 has an IC unit 91, which incorporates a non-contact type IC card dedicated for use in electronic settlement. Wireless communication is enabled by bringing the IC unit 91 close to an IC card reader of the POS system 30 and the like.

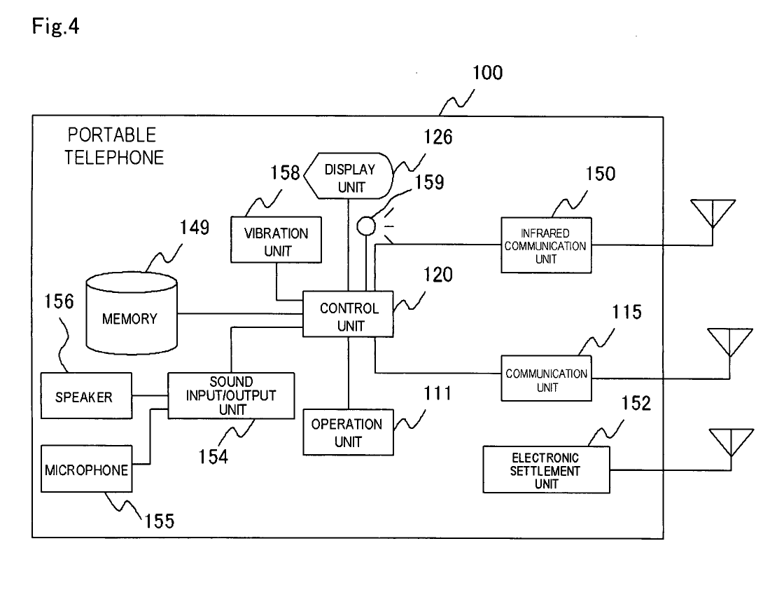

FIG. 4 is an outlined block diagram of a constitution of the portable telephone 100 of the present embodiment. The portable telephone 100 includes the above-described operation unit 111, communication unit 115, control unit 120, and display unit 126 as well as a memory 149, an infrared communication unit 150, an electronic settlement unit 152, a sound input/output unit 154, a microphone 155, a speaker 156, a vibration unit 158, and an LED indicator 159.

The memory 149 stores therein a program which controls the portable telephone 100 and set-up data and also includes a working area for the program. In the present embodiment of the information management system 200, some of the components shown in the functional block diagram of the portable telephone 100 of FIG. 2 are realized by this program. The infrared communication unit 150 is used to perform infrared communication with the POS system 30 by receiving and transmitting infrared light through the infrared communication window 87 of FIG. 3. The electronic settlement unit 152 is a non-contact type IC card dedicated for use in electronic settlement and corresponds to the IC unit 91 of FIG. 3.

The sound input/output unit 154 is controlled by the control unit 120, to input and output a sound through the microphone 155 and the speaker 156 respectively. The vibration unit 158 is controlled by the control unit 120 to vibrate the portable telephone 100 in a variety of patterns. The LED indicator 159, which is constituted of a plurality of different colored LEDs, is controlled by the control unit 120, to light up at a predetermined lighting-up/blinking interval and a predetermined arrangement and color pattern.

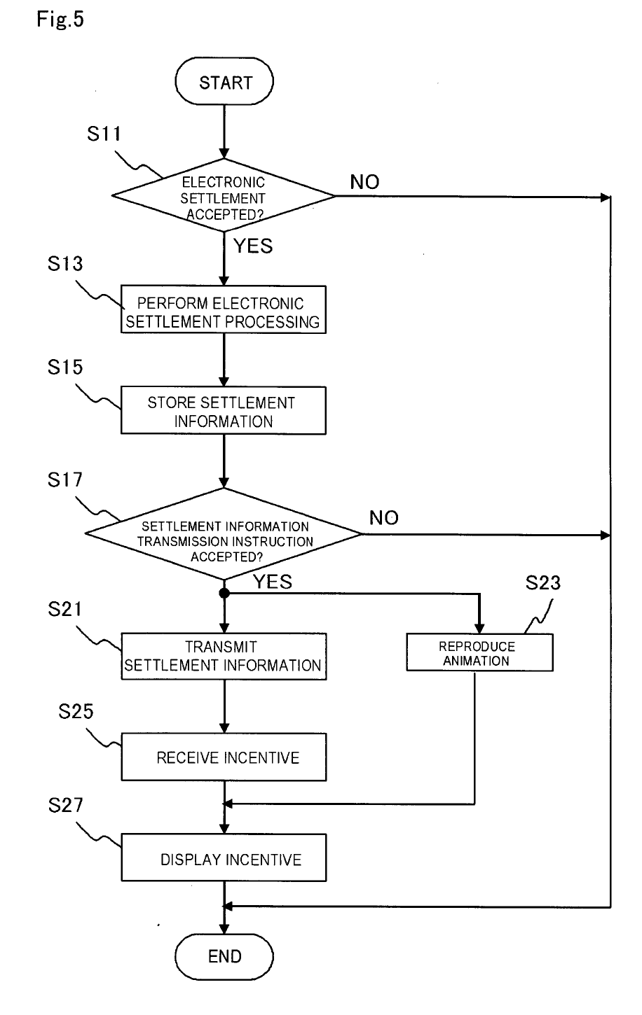

FIG. 5 is a flowchart of one example of electronic settlement processing by the portable telephone 100 in this embodiment. First, if the settlement instruction acceptance unit 101 accepts an electronic settlement instruction (YES at S11), the settlement unit 107 starts communication with the POS system 30 via the communication unit 103, to perform settlement processing (step S13). Then, the settlement unit 107 stores a result of the settlement in the settlement information storage unit 105 (step S15). Subsequently, the settlement unit 107 notifies the transmission instruction acceptance unit 113 of completion of the settlement, which transmission instruction acceptance unit 113 in turn queries the user 3 by way of the display unit 126 about whether or not to transmit settlement information to the information management server 50 and may accept a transmission instruction (step S17). If the transmission instruction is accepted (YES at S17), the settlement information transmission unit 117 transmits via the communication unit 115 to the information management server 50 the settlement information stored in the settlement information storage unit 105 and instructs the reproduction unit 122 to reproduce an animation of the content 131 (step S23).

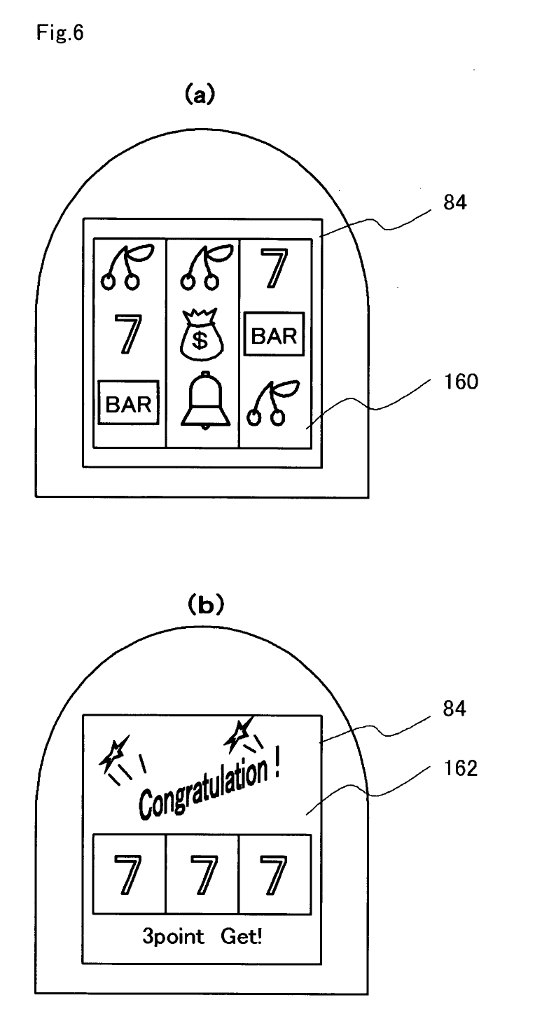

In this case, for example, an animation of a slot machine such as shown in FIG. 6(a) is displayed on the content display screen 160 of the liquid crystal display unit 84. Such an animation is displayed on the content display screen 160 by causing the reproduction unit 122 and the execution unit 124 to reproduce and execute various movie format files respectively. Along with the animation being reproduced, a mood sound may be reproduced. Moreover, the execution unit 124 may also execute a program to vibrate the vibration unit 158 in a predetermined pattern. Furthermore, the execution unit 124 may execute a program to cause the LED indicator 159 to light up and blink at a predetermined lighting-up/blinking interval and in a predetermined arrangement and color pattern. By thus effectively combining an image, a sound, a vibration, and a light, it is possible to provide the user 3 with an entertainment in richer expressions.

Referring back to FIG. 5, while the settlement information transmission unit 117 is transmitting the settlement information to the information management server 50, the animation is reproduced on the display unit 126. If the settlement information is completely received by the information management server 50, in return for that, incentive information and the like is transmitted as prize data to the portable telephone 100. In the portable telephone 100, the receiving unit 140 receives the incentive information from the information management server 50 via the communication unit 115 and stores it in the incentive hold unit 135 (step S25).

Prize data here refers to incentive data, which may be data which is received as a reward or an incentive in return for transmission of settlement information to the server, including incentive information such as a product prize or a cash prize and a point rebate service or an application software executable in the portable terminal and contents such as audio data, image data, and animation data reproducible in it. It is to be noted that the application software and the contents are stored in the content storage unit 130.

The prize data received and stored in the incentive hold unit 135 at step S25 is displayed on the display unit 126 by the reproduction unit 122 (step S27).

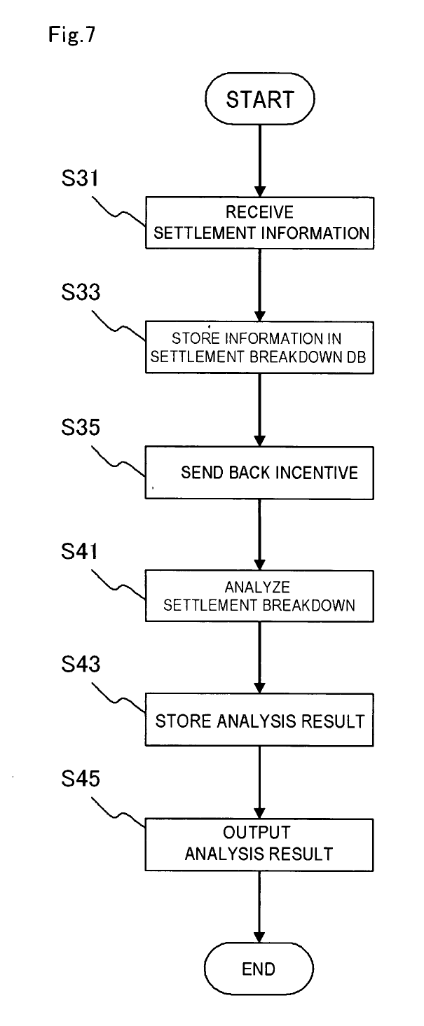

FIG. 7 is a flowchart of one example of settlement information gathering and analysis processing by the information management server 200 in this embodiment. First, the settlement information receiving unit 203 receives settlement information via the communication unit 201 from the portable telephone 100 (step S31). Subsequently, the settlement information received by the settlement information receiving unit 203 is stored into the settlement information database 52 (step S33). The judgment unit 205 decides whether or not reception of the settlement information is finished and, if it is finished, instructs the incentive donation unit 62 to donate incentive information. The incentive donation unit 62 accesses the allotment management database 54 to refer to allotment management information of the relevant portable telephone 100 and decides an allotment and outputs it as incentive information, thus causing the transmission unit 207 to transmit it to the portable telephone 100 (step S35). In this case, for example, the content 211 and the application software 213 stored in the content storage unit 60 may be used as prize data.

Moreover, in the information management system 200, the information analysis unit 70 of FIG. 1 performs analysis based on the gathered settlement information (step S41) and stores a result of the analysis into the analysis information storage unit 72 of FIG. 1 (step S43) and outputs it (step S45). When outputting the analysis result at step S45, data of the analysis result is transmitted to the server 10 in the manufacturer enterprise 9 via, for example, the internet 5.

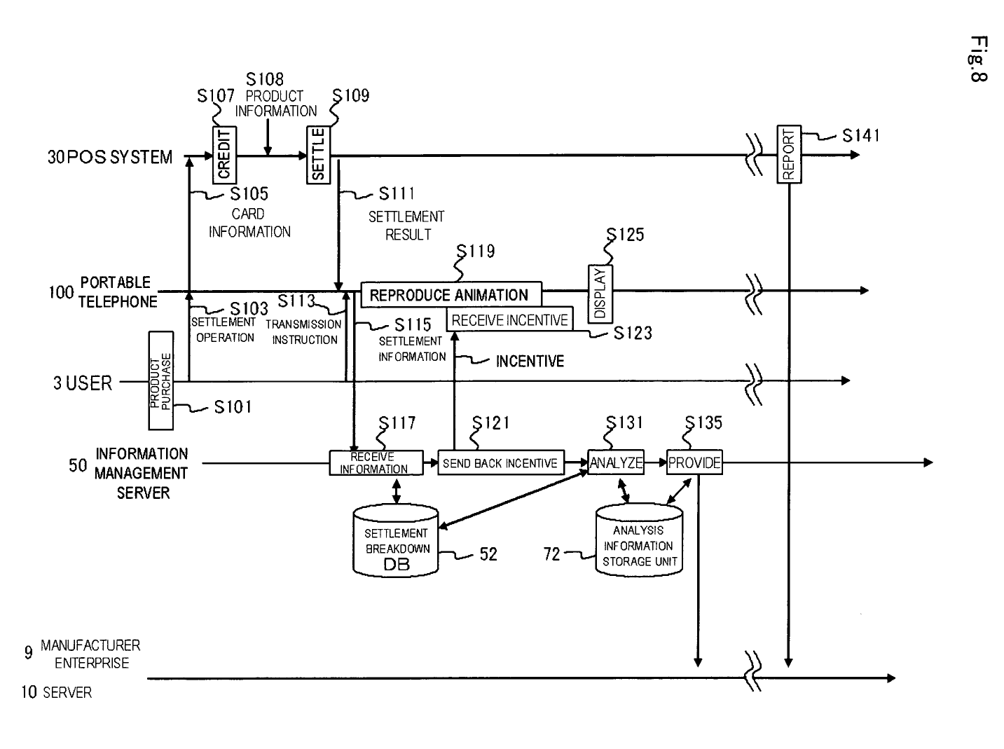

Operations of the information management system 200 having the above constitution will be described as follows. In the following description, FIGS. 1 to 8 are referred to. FIG. 8 is a chart of one example of the operations of the information management system 200 of the embodiment.

First, if the user 3 purchases a product in the affiliated store 7 (step S101), the user 3 operate the operation unit 111 of the portable telephone 100 to instruct electronic settlement (step S103). The settlement instruction acceptance unit 101 of the portable telephone 100 accepts the settlement instruction and the settlement unit 107 wirelessly communicates with the POS system 30 via the communication unit 103, to transmit card information or electronic money information (step S105). In the POS system 30, the server 20 accesses the credit settlement database 24 to give credit to the card information (step S107) and subsequently inputs information of the product (step S108) and performs settlement on it (step S109). In this case, the product information is input by, for example, reading a barcode or an IC tag attached to the product or accessing the product management database 22 to obtain the product information from a read code.

Subsequently, a result of the settlement is transmitted from the POS system 30 to the portable telephone 100 (steps S111), in the portable telephone 100, the settlement unit 107 stores the settlement result into the settlement information storage unit 105. Subsequently, the instruction which is given by the user 3 by operating the operation unit 111 of the portable telephone 100 to transmit settlement information to the information management server 50 is accepted by the transmission instruction acceptance unit 113 (step S113), and the settlement information transmission unit 117 transmits the settlement information via the transmission unit 115 to the settlement information management server 50 (step S115). In the operating company 1, the information management server 50 receives the settlement information (step S117). While the settlement information transmission unit 117 is transmitting the settlement information to the information management server 50, simultaneously, the reproduction unit 122 reproduces the content 131 to display an animation on the display unit 126 (step S119). In this case, as shown in FIG. 6(a), an animation of the slot machine is displayed on the content display screen 160. On the other hand, in the information management server 50, the settlement information received by the settlement information receiving unit 203 is stored in the settlement breakdown database 52.

In the information management server 50, if the judgment unit 205 judges that reception of the settlement information is finished, the incentive donation unit 62 accesses the allotment management database 54 to determine an allotment and transmits incentive information via the transmission unit 207 to the portable telephone 100 (step S121). In the portable telephone 100, the receiving unit 140 receives the incentive information via the communication unit 115 and stores it in the incentive hold unit 135 (step S123). Prize data received by the receiving unit 140 is stored in the content storage unit 130 and reproduced or executed by the reproduction unit 122 or the execution unit 124 respectively in the control unit 120, to be displayed on the display unit 126 (step S125). Further, the reproduction unit 122 or the execution unit 124 may access the incentive hold unit 135 to combine the incentive information into a screen and display it.

For example, such an incentive display screen 162 as shown in FIG. 6(a) is displayed. In this case, the number of points of an incentive obtained in return for the settlement information provided by the user 3 to the information management server 50 is displayed.

In such a manner, the user 3 performs electronic settlement via the portable telephone 100 and then transmits settlement information to the information management server 50, during which transmission an animation of, for example, a slot machine is displayed, so that the user may enjoy watching the animation, although it takes the user some time to transmit it. Further, the user may receive an incentive after transmitting the settlement information and so may be motivated to transmit the information. In such a manner, in the information management system 200 of the present invention, the information management server 50 can gather settlement information in real time.

Further, in FIG. 8, the information analysis unit 70 in the information management system 200 accesses the settlement breakdown database 52 to perform analysis based on the settlement information (step S131) and stores a result of the analysis into the analysis information storage unit 72. Subsequently, the information management server 50 transmits the analysis result to the server 10 in the manufacturer enterprise 9 via the internet 5 (step S135).

On the other hand, in the affiliated store 7, in the POS system 30, the server 20 transmits a report of a result of the settlement to the information management server 50 in the information management system 200 via the internet 5 (step S141). This report is released periodically, for example, once a day.

As described above, according to the present embodiment of the information management system 200 according to the present invention, in return for transmission of settlement information to the information management server 50, prize data is provided to the user 3, who may therefore be motivated to transmit the settlement information to the information management server 50. In such a manner, the information management server 50 can gather settlement information in real time. The thus gathered information may be quickly and effectively utilized, thus improving a quality of the information.

Further, according to the present embodiment of the information management system 200, by displaying an animation on the screen of the portable telephone 100 while settlement information is being transmitted to the information management server 50, the user 3 may be provided with a pleasure even during waiting for transmission and so motivated to transmit the information, thereby improving an efficiency to gather the information in real time.

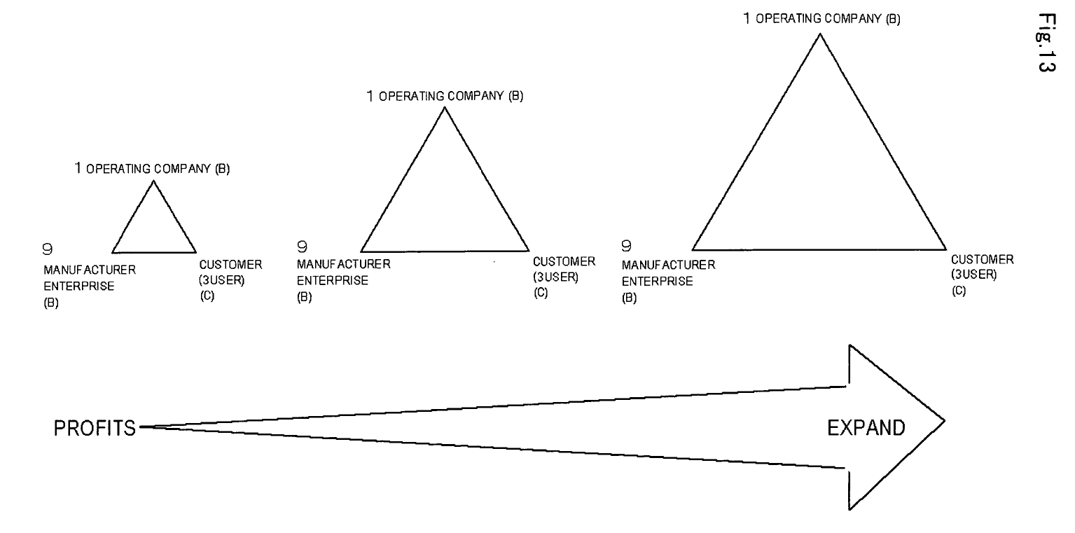

Further, according to the present embodiment of the information management system 200, an unconventional novel business model may be realized such as shown in FIG. 13. That is, a conventional business model has a structure in which profits are transferred between the operating company 1 and the manufacturer enterprise 9 (B(business) to B) or the manufacturer enterprise 9 and the user 3 (B to C(customer)), whereas the information management system according to the present invention can realize a structure in which profits circulates through B to B to B in this order or through B to B to C in this order, thereby providing a dynamic business model.

The user 3 may get an incentive in return for providing information upon purchase of a product, so that the operating company 1 may receive the information from the user 3 in real time and quickly deliver information of purchasing of the product by the consumer to the manufacturer enterprise 9, thereby improving information reliabilities and values as well as profits. Further, the manufacturer enterprise 9 may obtain information of purchase of a product by the consumer for sales-promoted products from the operating company 1 in real time and give an incentive to the user 3 via the operating company 1 to thus improve sales promotion effects, thereby improving advertising and attracting effects not only in the manufacturer enterprise 1 but also in the affiliated store 7 such as a convenience store or a mass retailer.

In such a manner, by the dynamic business model according to the present invention, it is possible to realize a structure in which the three parties (the operating company 1, the user 3, and the manufacturer enterprise 9 or the affiliated store 7) according to the present business model may all enjoy profits in such a manner that the profits may increase while circulating through the three parties virtuously.

### Second Embodiment

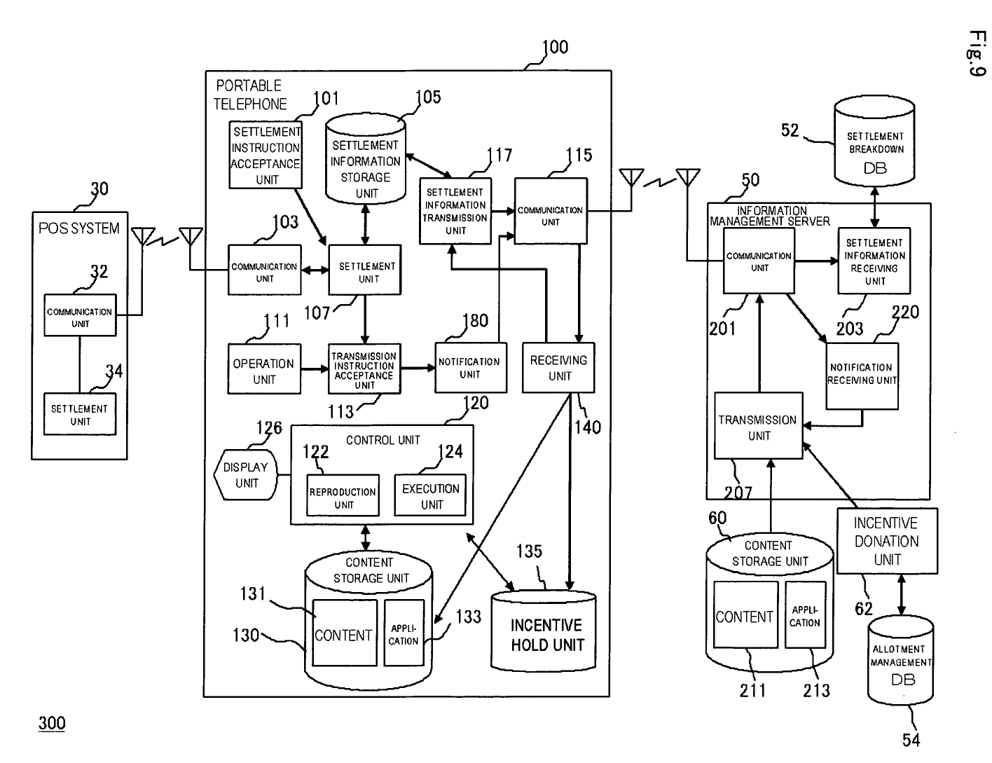

FIG. 9 is a functional block diagram of a constitution of an information management system 300 according to another embodiment of the present invention. The information management system 300 of the present embodiment is different from the information management system 200 of the above-described embodiment of FIG. 2 in that before settlement information is transmitted to the information management system 300, the settlement information is transmitted from the portable telephone 100 to the information management system 300 while prize data is received from the information management system 300 and reproduced or executed in a portable telephone 100.

The portable telephone 100 in the information management system 300 of the present embodiment includes a communication unit 180 in addition to the constitutional elements of FIG. 2. The communication unit 180 notifies an information management server 50 of transmission of settlement information via a communication unit 115 in response to a transmission instruction accepted by a transmission instruction acceptance unit 113.

Further, in the information management system 300, the information management server 50 includes a notification receiving unit 220 in place of the judgment unit 205 of FIG. 2. The notification receiving unit 220 receives a notification transmitted from the portable telephone 100 and gives it to a transmission unit 207. When having received the notification, the transmission unit 207 reads a content 211 or application software 213 from a content storage unit 60 and transmits it to the portable telephone 100 via a communication unit 201.

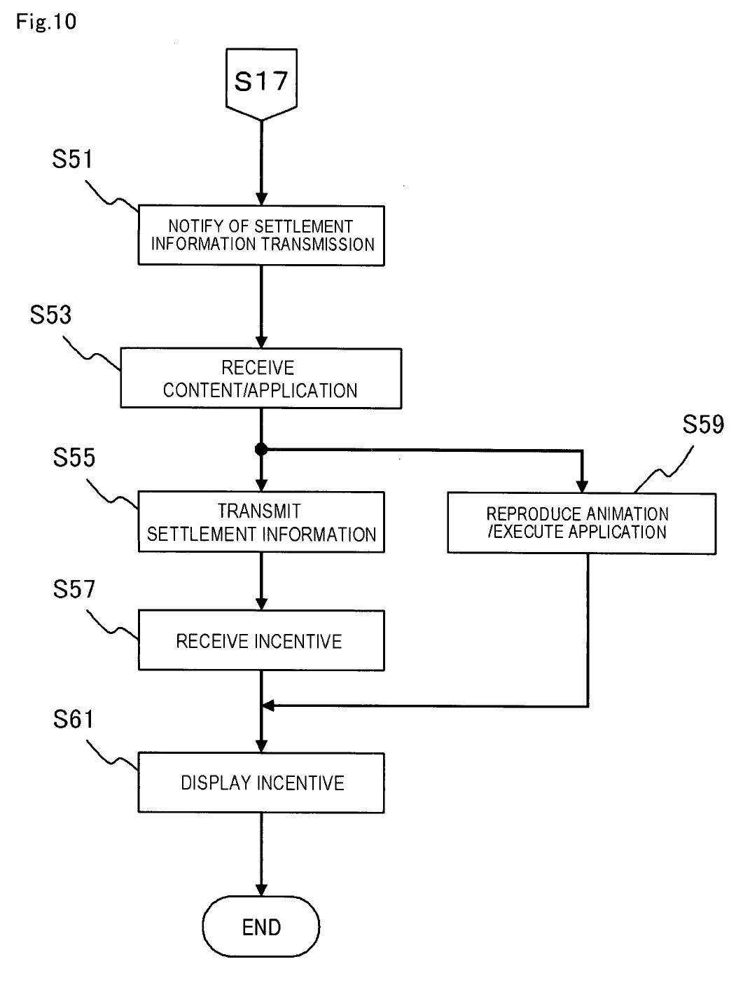

FIG. 10 is a flowchart of one example of electronic settlement processing by the portable telephone 100 of the present embodiment. In the present embodiment, the portable telephone 100 performs processing from steps S11 trough S17 of FIG. 5 and then, in response to a transmission instruction accepted by the transmission instruction acceptance unit 113, the notification unit 180 transmits a settlement information transmission notification to the information management 50 via the communication unit 115 (step S51).

Subsequently, a receiving unit 140 receives the content 211 or the application software 213 as prize data transmitted from the information management server 50 (step S53) and stores it in the content storage unit 130. The receiving unit 140 notifies a settlement information transmission unit 117 that the prize data is received, which settlement information transmission unit 117 in turn accesses a settlement information storage unit 105 to read settlement information and transmits the settlement information via the communication unit 115 to the information management server 50 (step S55). While the settlement information is being transmitted to the information management server 50, the portable telephone 100 reproduces or executes the received prize data by the reproduction unit 122 or the execution 124 respectively (step S59).

On the other hand, after the reception of the settlement information is finished at the information management server 50, incentive information transmitted to the portable telephone 100 is received via the communication unit 115 by the receiving unit 140 and stored in the incentive hold unit 135 (step S57). The control unit 120 accesses the incentive hold unit 135 and displays an incentive on a display unit 126 based on the incentive information (step S61).

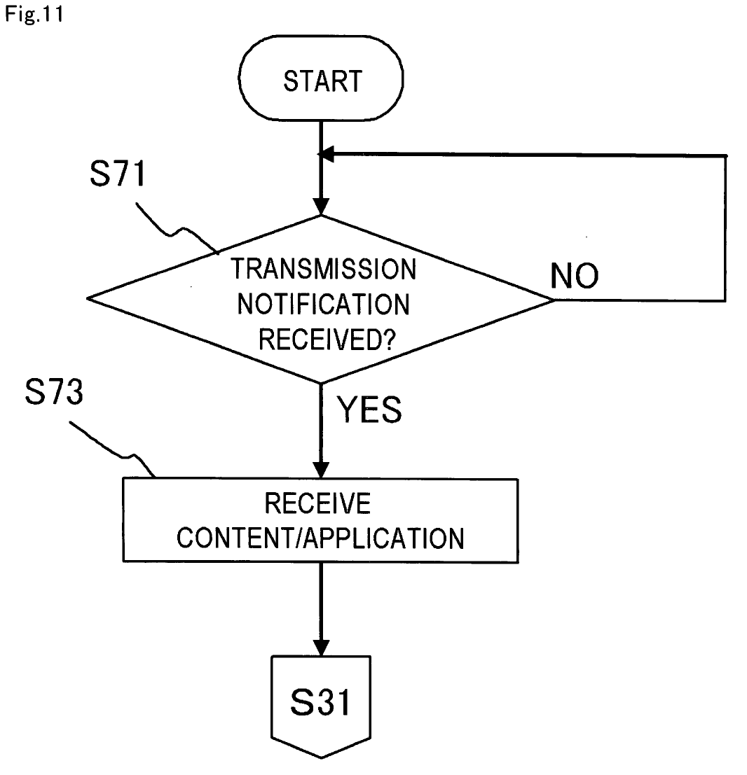

FIG. 11 is a flowchart of one example of electronic settlement/gathering processing by the information management server 50 in this embodiment. First, if the notification receiving unit 220 receives a settlement information transmission notification from the portable telephone 100 via the communication unit 201 (YES at step S71), the transmission unit 207 accesses the content storage unit 60 to read the content 211 or the application software 213 and transmits the content 211 or the application software 213 via the communication unit 201 to the portable telephone 100 (step S73). Then, the process goes to step S31 of FIG. 7. It is to be noted that the content 211 or the application software 213 transmitted from the information management server 50 to the portable telephone 100 presents a list which may be provided to the user 3 of the portable telephone 100 for that the user may select.

On the other hand, if the information management server 50 fails to receive the settlement information transmission notification from the portable telephone 100 (NO at step S71), reception of the transmission notification is monitored as it is.

As described above, according to the information management system 300 of the present embodiment, in return for transmission of settlement information from the information management server 50, a new content or program may be provided to the portable telephone 100 so that the user 3 may find pleasures in transmitting the settlement information to the information management server 50, thereby promoting transmission of the settlement information.

### Third Embodiment

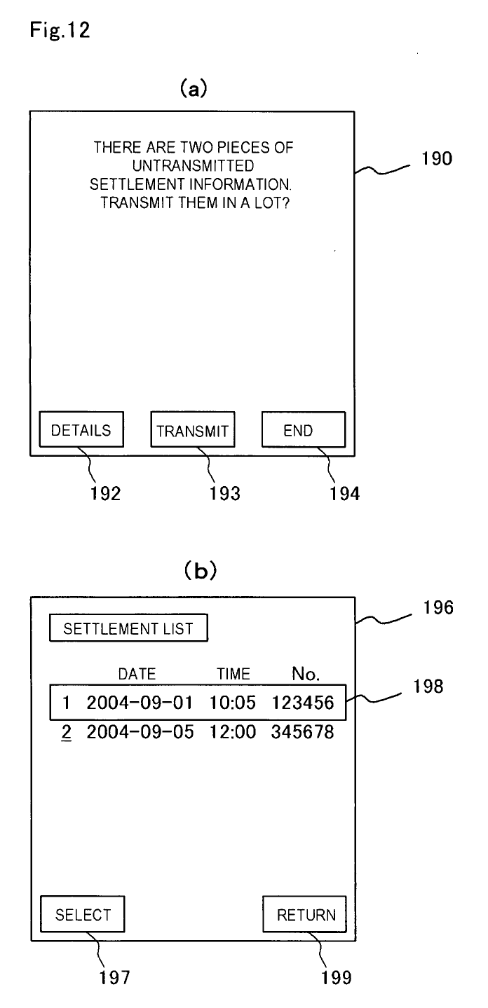

FIG. 12 is an illustration of an untransmitted information screen in an information management system of the present embodiment of the present invention. The present embodiment is different from the information management system of the above-described embodiment in that if settlement information fails to be transmitted upon purchase of a product, for example, if the user may not connect to the internet 5 due to an instable communication condition, the user may move to a place having a good communication condition to then transmit the settlement information. Although the present embodiment will be described as assumed to have the same constitution as that of the information management system 200 of FIG. 2, it may have the same constitution as that of the information management system 300 of FIG. 9.

FIG. 12(a) shows one example of an untransmitted information screen 190 and FIG. 12 (b) shows one example of a details list screen 196. The following description will be made with reference to FIGS. 2 and 12.

In a portable telephone 100 of the present embodiment, if it is impossible to transmit settlement information upon purchase of a product, the transmission instruction acceptance unit 113 indicates the untransmission on the untransmitted information screen 190 of the display unit 126, thereby notifying the user 3.

The untransmitted information screen 190 includes a details button 192, a transmission button 193, and an end button 194, so that if the transmission instruction acceptance unit 113 accepts pressing of the details button 192, the details list screen 196 of FIG. 12(b) is displayed on the display unit 126. The details list screen 196 includes a selection button 197 and a return button 199. When a cursor is moved to the number of a record of a settlement list displayed on the details list screen 196 and if pressing of the selection button 197 is accepted by the transmission instruction acceptance unit 113, reversed display 198 of the selected record is given.

If pressing of the return button 199 is accepted by the transmission instruction acceptance unit 113, screen returns to the untransmitted information screen 190 of FIG. 12(a). In this case, on the untransmitted information screen 190, the number of selected records is indicated by, for example, such a message as “Selected one of two settlement information pieces yet to be transmitted will be transmitted”, so that if pressing of the transmission button 193 is accepted by the transmission instruction acceptance unit 113, a settlement information transmission unit 117 transmits information of the selected record to the information management system 200. It is to be noted that if pressing of the end button 194 is accepted by the transmission instruction acceptance unit 113, the display unit 126 closes the untransmitted information screen 190 and switches to an ordinary standby screen.

As described above, according to the information management system of the present embodiment, if the user fails in connection to the server due to a poor communication condition, the user may move to a place having a good communication condition to immediately transmit settlement information again, so that the settlement information may be gathered at the earliest time as possible after purchase of a product.

### Fourth Embodiment

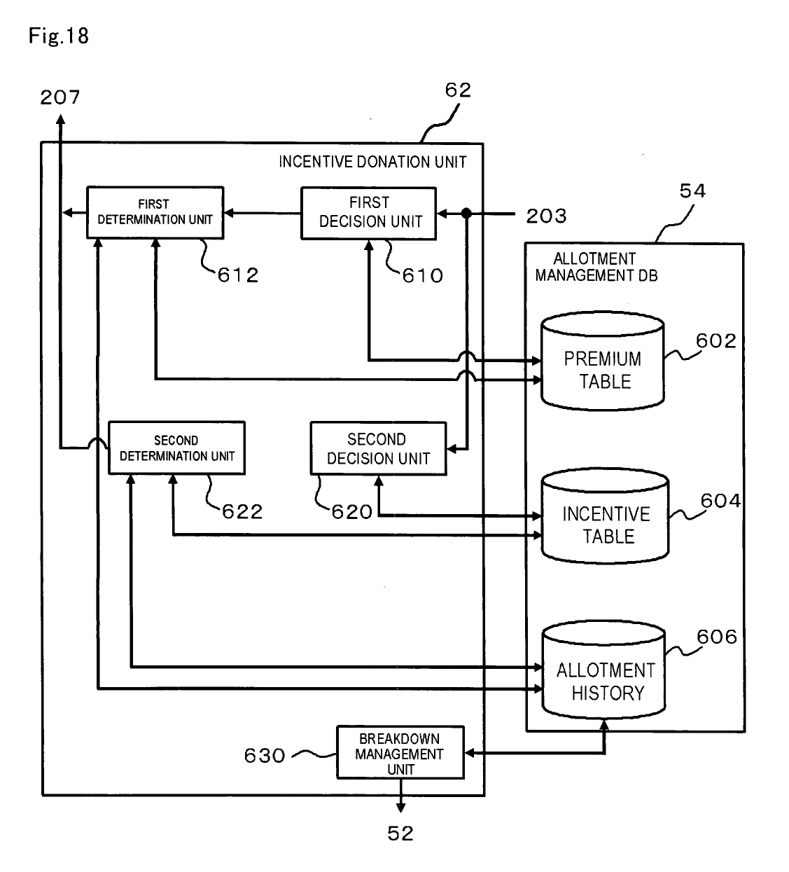

FIG. 18 is a functional block diagram of details of an incentive donation unit 62 and an allotment management database 54 of an information management system according to an embodiment of the present invention. In the present embodiment, a server (incentive donation unit 62) includes a first allotment table (premium allotment table 602) which registers a product to which first prize data is to be transmitted, a second allotment table which registers a product to which second prize data is to be donated, a first decision unit (first decision unit 610) which decides whether or not a product registered in the first allotment table is included immediately after settlement information is received by an information receiving unit (settlement information receiving unit 203), a second decision unit (second decision unit 620) which decides whether or not a product registered in the second allotment table is included posteriori after settlement information is received by the information receiving unit, a first determination unit (first determination unit 612) which determines prize data to be transmitted to a portable terminal (portable telephone 100) to which settlement information is transmitted if the first decision unit decides that the product is included, and a second determination unit (second determination unit 622) which determines prize data to be donated to a user account of the portable terminal to which the settlement information is transmitted if the second decision unit decides that the product is included.

The first prize data here may include, for example, information of a money amount or a point such as a product prize or a cash prize to be donated through a premium lottery carried out in real time when data is transmitted upon purchase of a product. Further, the second prize data refers to, for example, an incentive to be donated posteriori after a product is purchased and may include incentive information of a product prize or a cash prize and a point to be donated. It is to be noted that the first prize data is to be transmitted “immediately” with respect to the second prize data to be donated posteriori, so that simultaneity is not necessarily qualified.

Specifically, the incentive donation unit 62 includes the first decision unit 610, the second decision unit 620, the first determination unit 612, the second determination unit 622, and a breakdown management unit 630, while the allotment management database 54 includes the premium allotment table 602 (which is indicated as “incentive table” in the drawings) an incentive allotment table 604 (which is indicated as “incentive table” in the drawings) and an allotment history storage unit 606 (which is indicated as “allotment history” in the drawings).

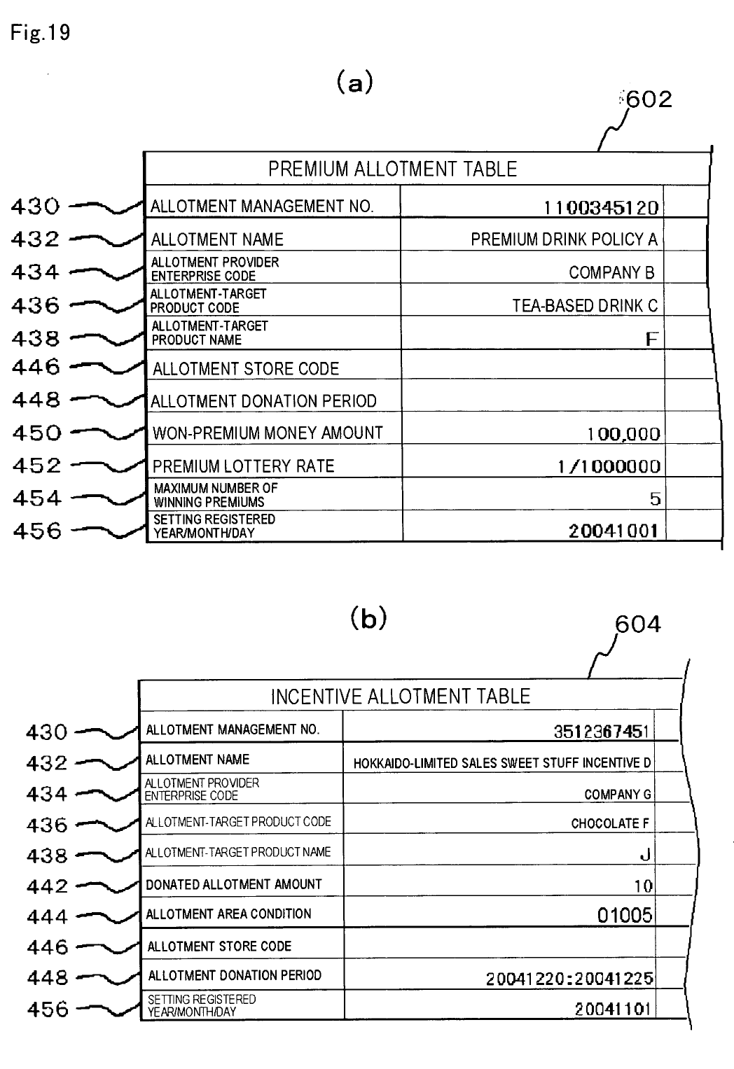

FIGS. 19(a) and 19(b) show one examples of structures of the premium allotment table 602 and the incentive allotment table 604 respectively. In such a manner, in the present embodiment, a table is divided into two tables of the premium allotment table 602 and the incentive allotment table 604, so that, for example, a premium lottery, which needs to be processed in real time when settlement information is received from the portable telephone 100, may be performed quickly. An incentive, which is to be donated to the user posteriori, may be processed by using the incentive allotment table 604 afterwards. Further, an incentive may be donated posterior in compensation for a transmission cost to be born by the user, thus motivating the user to transmit information. It is thus possible to realize well fitted trigger-based marketing capable of gathering information based on such a trigger that the user at the time of purchase of a product may be a source.

The allotment history storage unit 606 stores therein allotment history information of prize data transmitted by the transmission unit 207 for each user account of the portable telephone 100. The first decision unit 610 decides whether or not a product registered in the premium allotment table 602 is included immediately after settlement information is received by the settlement information receiving unit 203. The second decision unit 620 decides whether or not a product registered in the incentive allotment table 604 is included posteriori after settlement information is received by the settlement information receiving unit 203.

If the first decision unit 612 decides that a product is included, the first determination unit 612 determines prize data to be transmitted to the portable telephone 100 from which the settlement information is transmitted, by referencing the premium allotment table 602 and the allotment history storage unit 606. If the second decision unit 620 decides that a product is included, the second determination unit 622 determines prize data to be donated to the user account of the portable telephone 100 from which settlement information is transmitted, by referencing the incentive allotment table 604 and the allotment history storage unit 606. It is thus possible to upgrade a level of prize data to be transmitted and change a type of the prize data.

The breakdown management unit 630 additionally records the donated incentive information into the breakdown information 408 of the settlement breakdown database 52 of FIG. 14 by referencing the allotment history storage unit 606. In such a manner, the breakdown information 408 may be recorded into the settlement breakdown database 52 by the breakdown management unit 630 through batch processing separately from processing such as a real time premium lottery at the time of reception of settlement information.

By this constitution, it is possible to manage the first prize data transmitted immediately after settlement information is received from the portable terminal and the second prize data donated posteriori by dividing them into two tables and perform only processing by use of the first prize data, thereby more quickly performing processing when settlement information is transmitted from the portable telephone.

Although the embodiments of the present invention have been described with reference to the drawings, the present invention is not limited to these examples and may employ various constitutions other than the above.

For example, although the above embodiments have employed such a constitution that the POS system 30 would perform electronic settlement by use of the portable telephone 100 in the affiliated store 7, the present invention is not limited thereto. For example, such a constitution may be employed that electronic settlement by use of the portable telephone 100 would be performed by paying a fee by using prepaid type electronic money upon purchase of a product at an automatic vending machine.

Further, in an information management system of any other embodiment of the present invention, the portable terminal (portable telephone 100) may include a procedure table, not shown, which stores a chained order of a plurality of contents (contents 131) or programs (application software pieces 133) stored in the prize data storage unit (content storage unit 1309), so that the control unit (control unit 120, reproduction unit 122, and execution unit 124) may sequentially reproduce or execute the plurality of contents or programs respectively in the chained order described in the procedure table each time the settlement information is transmitted to the server (information management server 50).

For example, a content of displaying an animation of such a slot machine as shown in FIG. 6 of the above-described embodiment may be represented by three contents obtained by stopping the rotation of three columns one by one, to store an order of the reproduction of the three contents in the procedure table. Each time the user transmits settlement information to the information management server 50, the reproduction unit 122 would sequentially reproduce the contents in the chained order stored in the procedure table. Alternatively, it may be constituted of a plurality of contents that display an animation of a bingo game.

By this constitution, chained continuity may be given to contents or programs presented to the user 3 when the settlement information is transmitted, so that the user 3 may have a wish to see a sequel, thereby causing opportunity, that is, a trigger to be triggered to have an intention to transmit information to continue for a long period.

1. An information management system comprising a portable terminal having a settlement unit which performs electronic settlement and a server which gathers and manages settlement information of the electronic settlement performed by said portable terminal, wherein:
said portable terminal includes:
an information transmission unit which transmits said settlement information to said server;
a data receiving unit which receives prize data from said server after transmission of said settlement information to said server; and
a prize data storage unit which stores therein said prize data received by said data receiving unit; and
said server includes:
an information receiving unit which receives said settlement information;
a settlement information database which stores therein said settlement information received;
a prize data storage unit which stores therein the prize data to be sent back to said portable terminal when said settlement information is received by said information receiving unit; and
a data transmission unit which transmits said prize data to said portable terminal when said settlement information is received from said portable terminal.

2. The information management system according to claim 1, wherein:
said portable terminal includes:
a content storage unit which stores therein a content and a program;
a control unit which reproduces and executes said content and program respectively; and
a display unit which displays a screen which is displayed when said control unit reproduces and executes said content and program respectively; and
in said portable terminal;
if the electronic settlement is performed by said settlement unit, said control unit causes said display unit to display said screen; and
while said screen is being displayed, said information transmission unit transmits said settlement information to said server.

3. The information management system according to claim 1, wherein:
said portable terminal includes an acceptance unit which accepts an instruction to transmit said settlement information to said server; and
if said instruction is accepted by said acceptance unit, said control unit may cause said display unit to display said screen and said information transmission unit transmits said settlement information to said server.

4. The information management system according to claim 1, wherein:
said portable terminal includes:
a notification unit which transmits an information transmission notification before transmitting said settlement information to said server; and
a content receiving unit which receives a new content or program from said server and stores the new content or program in said content storage unit; and
said server includes:
an acceptance unit which accepts said information transmission notification;
a storage unit which stores therein said new content and program; and
a content transmission unit which transmits said new content or program to said portable terminal if said information transmission notification is accepted.

5. A portable terminal comprising:
a settlement unit which performs electronic settlement;
an information transmission unit which transmits settlement information of electrical settlement performed by said settlement unit to an information management server;
a data receiving unit which receives prize data from said information management server after said settlement information is transmitted to said information management server; and
a prize data storage unit which stores said prize data received by said data receiving unit.

6. The portable terminal according to claim 5, comprising:
a content storage unit which stores therein a content and a program;
a control unit which reproduces and executes said content and program respectively; and
a display unit which displays a screen which is displayed when said control unit reproduces and executes said content and program respectively,
wherein if the electronic settlement is performed by said settlement unit, said control unit causes said display unit to display said screen and,
while said screen is being displayed, said information transmission unit transmits said settlement information to said server.

7. The portable terminal according to claim 5, comprising an acceptance unit which accepts an instruction to transmit said settlement information to said information management server,
wherein if said instruction is accepted by said acceptance unit, said control unit causes said display unit to display said screen and said information transmission unit transmits said settlement information to said information management server.

8. The portable terminal according to claim 5, comprising a sound output unit which outputs a sound, wherein:
said content stored in said content storage unit includes audio data which is output by said sound output unit; and
when said screen of said display unit is displayed, simultaneously said audio data is output from said sound output unit.

9. The portable terminal according to claim 5, comprising a vibration unit which vibrates in a predetermined vibration pattern,
wherein when said screen of said display unit is displayed, simultaneously said vibration unit vibrates in said predetermined vibration pattern.

10. The portable terminal according to claim 5, comprising a light source unit which lights up at a predetermined lighting-up/blinking interval and in a predetermined arrangement and color pattern,
wherein when said screen of said display unit is displayed, simultaneously said light source unit lights up at said predetermined lighting-up/blinking interval and in said predetermined arrangement and color pattern.

11. An information management server comprising:
an information receiving unit which receives settlement information from a portable terminal which performs electronic settlement;
a settlement information database which stores therein said settlement information received;
a prize data storage unit which stores the prize data to be sent back to said portable terminal when said settlement information is received by said information receiving unit; and
a data transmission unit which transmits said prize data to said portable terminal when said settlement information is received from said portable terminal.

12. A program that causes a portable terminal including:
a settlement unit which performs electronic settlement;
a prize data storage unit which stores prize data to be transmitted from an information management server;
a content storage unit which stores a content and a program; and
a display unit, to function as:
an execution means which reproduces and executes said content and said program respectively if the electronic settlement is performed by said settlement unit;
a display control means which displays said content and said program on a screen of said display unit if said content and said program are reproduced and executed respectively by said execution means;
an information transmission means which transmits settlement information of the electronic settlement performed by said settlement unit to said information management server during said screen is being displayed; and
a data receiving means which, after transmission of said settlement information to said information management server, receives the prize data from said information management server and stores it in said prize data storage unit.

13. The program according to claim 12, wherein:
said portable terminal is functioned as an acceptance means which accepts an instruction to transmit said settlement information to said information management server; and
if said instruction is accepted by said acceptance means, said execution means reproduces and executes said content and said program, respectively, and if said display control means displays said screen on said display unit, simultaneously said information transmission means transmits said settlement information to said information management server.

14. The information management system according to claim 1, wherein said prize data includes:
first prize data which is transmitted to said portable terminal by said data transmission unit of said server immediately after said settlement information is received by said server from said portable terminal; and
second prize data which is donated posteriori for each user account of said portable terminal after said settlement information is received by said server from said portable terminal.

15. The information management system according to claim 14, wherein said server includes:
a first allotment table which registers a product to which said first prize data is to be transmitted;
a second allotment table which registers a product to which said second prize data is to be donated;
a first decision unit which decides whether said product registered in said first allotment table is included or not, immediately after said settlement information is received by said information receiving unit;
a second decision unit which decides whether said product registered in said second allotment table is included or not, posteriori after said settlement information is received by said information receiving unit;
a first determination unit which determines said prize data to be transmitted to said portable terminal to which said settlement information is transmitted if said first decision unit decides that said product is included; and
a second determination unit which determines said prize data to be donated to a user account of said portable terminal to which said settlement information is transmitted if said second decision unit decides that said product is included.

16. The information management system according to claim 14, wherein:
said server includes an allotment history storage unit which stores therein allotment history information of said prize data transmitted by said data transmission unit for each account of a user of said portable terminal; and
when said settlement information is received by said information receiving unit, said first determination unit and said second determination unit refer to said allotment history storage unit to thereby determine said prize data to be transmitted by said data transmission unit and store said allotment history information in said allotment history storage unit.

17. The information management system according to claim 2, wherein:
said portable terminal includes a procedure table which stores therein a chained order of a plurality of contents or programs stored in said prize data storage unit; and
said control unit in said portable terminal sequentially reproduces or execute said plurality of contents or programs respectively in said chained order described in said procedure table each time said settlement information is transmitted to said server.

18. The information management system according to claim 2, wherein:
said portable terminal includes an acceptance unit which accepts an instruction to transmit said settlement information to said server; and
if said instruction is accepted by said acceptance unit, said control unit may cause said display unit to display said screen and said information transmission unit transmits said settlement information to said server.

19. The information management system according to claim 2, wherein:
said portable terminal includes:
a notification unit which transmits an information transmission notification before transmitting said settlement information to said server; and
a content receiving unit which receives a new content or program from said server and stores the new content or program in said content storage unit; and
said server includes:
an acceptance unit which accepts said information transmission notification;
a storage unit which stores therein said new content and program; and
a content transmission unit which transmits said new content or program to said portable terminal if said information transmission notification is accepted.

20. The information management system according to claim 3, wherein:
said portable terminal includes:
a notification unit which transmits an information transmission notification before transmitting said settlement information to said server; and
a content receiving unit which receives a new content or program from said server and stores the new content or program in said content storage unit; and
said server includes:
an acceptance unit accepts said information transmission notification;
a storage unit which stores therein said new content and program; and
a content transmission unit which transmits said new content or program to said portable terminal if said information transmission notification is accepted.
